(19) United States
(12) Patent Application Publication
(10) Pub. No.: US 2006/0041515 A1
(43) Pub. Date: Feb. 23, 2006

(54) On-site point-of-sale billing system which manages public use of wired or wireless access network

(75) Inventor: Steven Wollmershauser, San Antonio, TX (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/918,220

(22) Filed: Aug. 13, 2004

(51) Int. Cl. G06Q 99/00

(52) U.S. Cl. 705/76

(57) ABSTRACT

A wireless access point is deployed at a business location to provide a public wireless local area network (PWLAN) having access to the Internet. A computer at the business location facilitates transactions of selling access to the PWLAN and facilitates transactions of goods or services other than access to the PWLAN. An on-site software component receives an amount paid for PWLAN access either by polling a point-of-sale software component of the computer or by receiving a manually-entered input of the amount paid. An on-site password generator issues a password to access the PWLAN based on a transaction for PWLAN access. An on-site authentication component and an on-site timeout component act to determine whether to allow or deny an attempt to access the PWLAN based on a password received by the wireless access point and based on whether the received password has an associated amount of remaining time of PWLAN access.

### FIELD OF THE DISCLOSURE

The present disclosure relates to methods and systems for billing for a public wired or wireless access network.

### DESCRIPTION OF THE RELATED ART

Public Wireless Local Area Networks (PWLANs) provide public access to the Internet using a wireless standard such as 802.11x or WiFi. PWLANs are presently available at many coffee shops, bookstores, airports and hotels, for example. PWLAN-supporting software passes information from a PWLAN location to a centralized server that performs billing and network access authentication. The centralized servers use remote authentication through a network connection to a Remote Authentication Dial-In User Service (RADIUS) or other type of server. This server authenticates users of a PWLAN service, and either allows users to pay for Internet usage through the network using credit cards or verifies if an existing monthly account status is current.

From a perspective of keeping server costs down, use of the centralized server is beneficial for businesses that have or operate multiple PWLANs at multiple locations. However, having a third party company collect and manage the information sent to the centralized server introduces an additional expense.

### BRIEF DESCRIPTION OF THE DRAWINGS

The present invention is pointed out with particularity in the appended claims. However, other features are described in the following detailed description in conjunction with the accompanying drawings in which:

FIG. 1 is a block diagram of an embodiment of a system for providing a PWLAN at a single location of a small business; and

FIG. 2 is a flow chart of an embodiment of a method of providing the PWLAN at the single location.

### DETAILED DESCRIPTION OF THE DRAWINGS

Disclosed herein are embodiments of PWLAN-supporting software that holds the billing and authentication server functions within a single location of a small business, and thus eliminates the need for accessing a centralized server and its associated costs. Small business owners can leverage their existing merchant account systems and point-of-sale software systems to perform the tasks that third party software companies are currently providing for a fee.

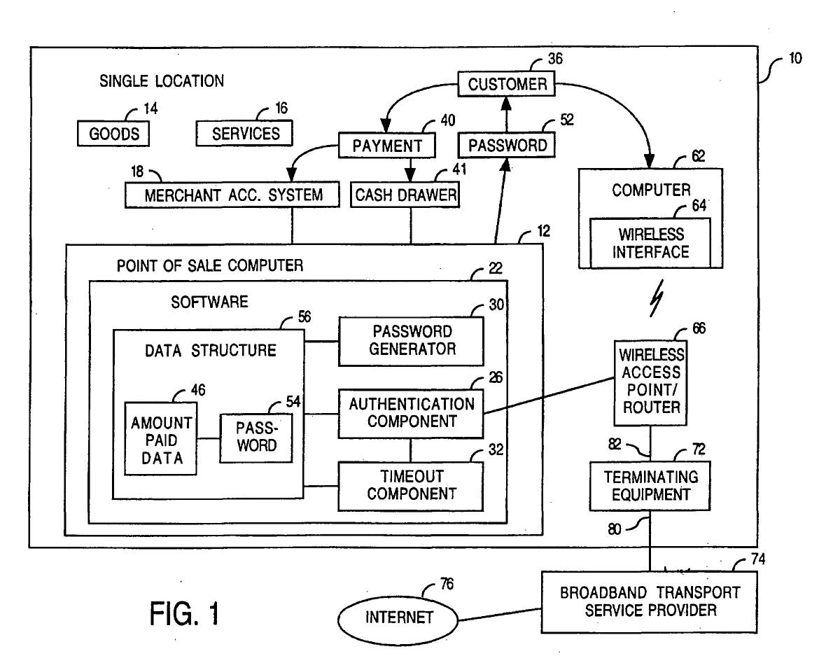

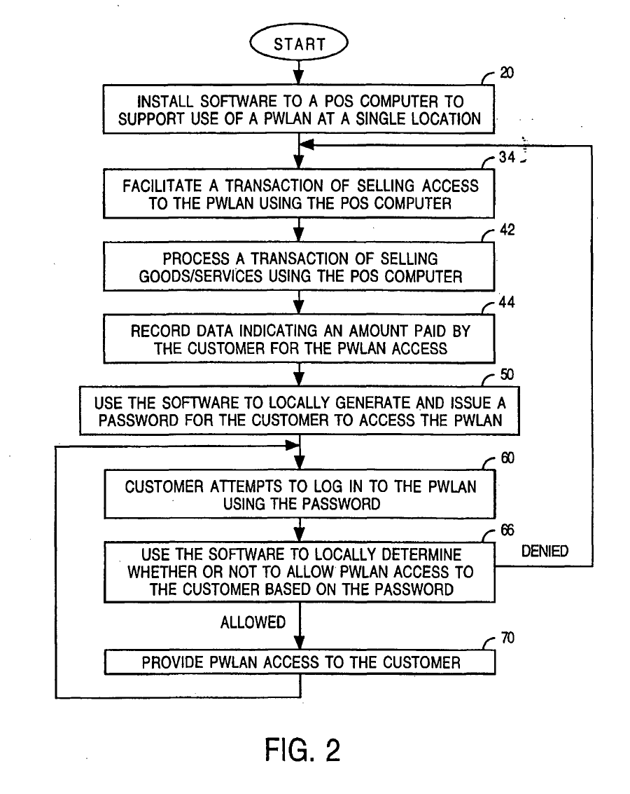

Embodiments of the present invention are described with reference to FIG. 1, which is a block diagram of an embodiment of a system for providing a PWLAN at a single location 10 of a small business, and FIG. 2, which is a flow chart of an embodiment of a method of providing a PWLAN at the single location 10.

At the single location 10 resides a computer 12 that may be used for a point-of-sale system owned by the small business. The computer 12 is used to facilitate transactions of various goods 14 and services 16 sold by the small business in its normal course of business. A merchant account system 18 may be connected to the computer 12 to provide a merchant account service for the small business to accept credit card transactions.

As indicated by block 20, the method comprises installing software 22 to the computer 12 to support use of a PWLAN at the location 10 of the small business. The software 22 is stored as computer-readable program code on a computer-readable medium. The software 22 comprises an authentication component 26 which directs the computer 12 to act as a server to authenticate users based on an authentication process, such as an 802.1x authentication process for example. The software 22 further comprises a password generator 30 which directs the computer 12 to generate passwords that are issued to users of the PWLAN at the location 10 of the small business. The software still further comprises a timeout component 32 which directs the computer 12 to provide a timeout feature assigned to each password.

As indicated by block 34, the method comprises facilitating a transaction of selling access to the PWLAN to a customer 36 of the small business. Access is sold to the customer 36 at the location 10 of the small business. The customer 36 pre-pays for the PWLAN access in person using a form of payment 40 such as cash, a credit card or a debit card, for example. The customer 36 can provide the form of payment 40 for PWLAN access to either a cashier at a sales counter, a self-serve checkout system, or another place at which sales of goods and services provided by the small business are finalized at the location 10. Credit card payments are processed by the merchant account system 18. Cash payments are received by a cash drawer 41 or an alternative cash-receiving receptacle.

As indicated by block 42, the method optionally comprises processing a transaction of selling one or more of the goods 14 and/or services 16 to the customer 36, in addition to the PWLAN access, using the computer 12. The customer 36 pays for the goods/services transaction in the same manner as paying for the PWLAN-access transaction. Specifically, the customer 36 pays for the goods/services transaction by providing the form of payment 40 to either the cashier at the sales counter, the self-serve checkout system, or another place at which sales are finalized at the location 10. Credit card payments are processed by the merchant account system 18, and cash payments are received by the cash drawer 41 or alternative cash-receiving receptacle.

As those having ordinary skill can appreciate, the order of performing the acts indicated by blocks 34 and 42 can be reversed.

As indicated by block 44, the method comprises recording data 46 indicating an amount paid by the customer 36 for the PWLAN access. The amount paid data 46 is recorded by the software 22 in the computer 12. The software 22 may poll a POS software component for the amount paid, and may record the data 46 based on the amount paid. Alternatively, the amount paid is manually-entered (e.g. typed) by a user, which causes the software 22 to record the amount paid data 46. The amount paid may be manually entered if the payment 40 is a cash payment, for example. A subsequent attempt to access the PWLAN is conditional on the amount paid for the transaction for PWLAN access being either recorded by the POS software component or user-entered as described above.

As indicated by block 50, the method comprises generating and issuing a password 52 to the customer 36. The password 52 is generated by the password generator 30 to uniquely identify access associated with the PWLAN-access transaction. The password generator 30 records data 54 indicating the password 52 in the computer 12 and associates same with the amount paid data 46. The association of the amount paid data 46 and the password data 54 may be stored by a data structure 56, such as a table, created by the software 22. Based on the amount paid data 46, the software 22 determines a length of time that the password 54 can be used to provide PWLAN access. For example, based on the amount paid data 46, the password 52 may be active for a day, a week, or a month.

The authentication component 26 accesses the data structure 56 to authenticate log-ins to the PWLAN. The authentication component 26 recognizes when a password is being used, and will not allow duplicate log-ins for the password. As a result, each password is restricted to a single authentication at any given point in time.

The computer 12 issues the password 52 to the customer 36. The computer 12 may write the password 52 to a medium that is provided to the customer 36. In one embodiment, a hard copy of the password 52 printed by the computer 12 is provided to the customer 36.

As indicated by block 60, the method comprises the customer 36 attempting to log in to the PWLAN at the location 10 using a computer 62 with a wireless interface 64. The customer 36 attempts to log in using the password 52. The computer 62 communicates the password 52 via the wireless interface 64 to a wireless access point 66 deployed at the location 10. The wireless access point 66 is in communication with the computer 12.

The wireless interface 64 and the wireless access point 66 may communicate via a standard such as 802.11a, b or g, for example. The computer 62 may comprise a notebook/laptop or handheld computer, and the wireless interface 64 may comprise a wireless networking card installed in the computer 62. The computer 62 may be owned by the customer 36. Alternatively, the small business may supply the computer 62 to the customer 36.

As indicated by block 66, the authentication component 26 determines whether or not to allow PWLAN access to the customer 36 based on the password 52. The authentication component 26 allows PWLAN access if the password 52 is valid, if the password 52 has associated therewith some remaining length of time of pre-paid PWLAN access as determined by the timeout component 32, and if no other users are logged in with the same password 52. Otherwise, the authentication component 26 denies and inhibits PWLAN access. If denied, the customer 36 can purchase additional PWLAN access as indicated by flow of the method being directed back to block 34.

As indicated by block 70, the method comprises providing PWLAN access to the customer 36 if allowed by the authentication component 26. The PWLAN is provided by the wireless access point 66, which is interfaced with terminating equipment 72 coupled to a broadband transport 74. The broadband transport 74 may comprise of a Digital Subscriber Line (DSL) or another type of bandwidth transport. The terminating equipment 72 may be an integrated device having a broadband interface on a wide-area network (WAN) side 80 and a wireless router on a LAN side 82, or may be made up of individual products. The terminating equipment 72 can provide an Ethernet interface to interface with the wireless access point 66. The wireless access point 66 may comprise an 802.11x compliant access point with an integrated router used to connect multiple computers to the terminating equipment. The broadband transport 74 provides PWLAN users access to the Internet 76 via XDSL, cable modem, or another transport service.

Although the method is illustrated for a single customer of PWLAN access, those having ordinary skill will recognize that the teachings extend to any number of customers of PWLAN access at the location 10 of the small business. Further, although the method is illustrated for one small business, those having ordinary skill will recognize that the teachings extend to any number of single-location, small businesses.

Embodiments of the present invention open a new market segment for PWLAN services which benefits single-location small businesses, wireless access customers of the small businesses, and service providers of the broadband transport 74. The single-location, small business gains additional revenue from the sale of Internet access to its customers, and benefits by increased customer satisfaction and customer retention associated with Internet access without having to use a remote server to provide Internet access. New revenue opportunities result for the service provider of the broadband transport 74 by: sales of transport services to many single-location, small businesses; sales of the software 22 to the small businesses; sales of the computer 12 that runs the software 22 to the small businesses; and new managed service revenue from offering Tier 2 support. Optionally, the single-location, small business pays the service provider of the broadband transport 74 based on sales of Internet access, but otherwise is given free access to the Internet 76 via the broadband transport 74. The customers benefit by being given low-cost single time or time-based access to the Internet 76, and by conveniently having access to e-mail and Web sites while in the vicinity of the small business (e.g. in range of the wireless signal) during or outside normal business hours.

It will be apparent to those skilled in the art that the disclosed embodiments may be modified in numerous ways and may assume many embodiments other than the particular forms specifically set out and described herein. For example, the teachings herein may be used to provide a public wireline local area network instead of a public wireless local area network. Further, the software 22 and its components 26, 30 and 32 depicted as being on-site the location 10 and being provided by the computer 12 can be provided by a different computer such as a billing system computer that interfaces with the computer 12. Like the computer 12, the different computer would be located on-site at the location 10.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A system comprising:
a wireless access point to provide, at a business location, a public wireless local area network (PWLAN) having access to the Internet; and
a computer at the business location to facilitate transactions of selling access to the PWLAN and to facilitate transactions of goods or services other than the access to the PWLAN, the computer comprising a password generator to issue a password to access the PWLAN based on a transaction for PWLAN access, the computer further comprising an authentication component and a timeout component to determine whether to allow or deny an attempt to access the PWLAN via the wireless access point based on a password received by the wireless access point and based on whether the received password has an associated amount of remaining time of PWLAN access.

2. The system of claim 1 wherein a condition to allow the attempt to access the PWLAN is that an amount paid for the transaction for PWLAN access was either recorded by a point-of-sale software component of the computer or was manually entered.

3. The system of claim 1 wherein the authentication component is to deny access to the PWLAN if another user is logged in with the received password.

4. The system of claim 1 wherein the computer is connected to a merchant account system.

5. A method comprising:
deploying a wireless access point at a business location to provide a public wireless local area network (PWLAN) having access to the Internet;
facilitating a transaction of selling access to the PWLAN using a computer at the business location;
facilitating transactions of goods or services other than the access to the PWLAN using the computer;
generating and issuing a password, by a password generator at the business location, to access the PWLAN based on the transaction for access to the PWLAN;
receiving, by the wireless access point, an attempt to access by the PWLAN using the password; and
determining, by an authentication component and a timeout component at the business location, whether to allow or deny access to the PWLAN based on the password received by the wireless access point and based on whether the password has an associated amount of remaining time of PWLAN access.

6. The method of claim 5 further comprising:
providing the PWLAN access using the wireless access point if the attempt is allowed in said act of determining.

7. The method of claim 5 wherein said act of determining comprises denying access to the PWLAN when another user is logged in with the received password.

8. The method of claim 5 wherein the computer is connected to a merchant account system.

9. A computer-readable medium which stores computer-readable program code which causes a computer at a business location to facilitate transactions of selling access to a public wireless local area network (PWLAN) in addition to facilitating transactions of goods or services other than the access to the PWLAN, the computer-readable program code providing a password generator to issue a password to access the PWLAN based on a transaction for PWLAN access, the computer-readable program code further providing an authentication component and a timeout component to determine whether to allow or deny an attempt to access the PWLAN based on a password received by a wireless access point and based on whether the received password has an associated amount of remaining time of PWLAN access.

10. The computer-readable medium of claim 9 wherein a condition to allow the attempt to access the PWLAN is that an amount paid for the transaction for PWLAN access was either recorded by a point-of-sale software component of the computer or was manually entered.

11. The computer-readable medium of claim 9 wherein the authentication component is to deny access to the PWLAN when another user is logged in with the received password.
